(19) United States
(12) Patent Application Publication
(10) Pub. No.: US 2023/0362881 A1
(43) Pub. Date: Nov. 9, 2023

(54) METHODS AND APPARATUSES FOR A RELAY RESELECTION AND DATA TRANSMISSION HANDLING PROCEDURE IN A UE-TO-NETWORK RELAY SCENARIO

(71) Applicant: Lenovo (Beijing) Limited, Beijing (CN)

(72) Inventors: Lianhai Wu, Beijing (CN); Mingzeng Dai, Shanghai (CN); Congchi Zhang, Shanghai (CN); Ran Yue, Beijing (CN)

(73) Assignee: Lenovo (Beijing) Limited, Beijing (CN)

(21) Appl. No.: 18/246,935

(22) PCT Filed: Sep. 30, 2020
(86) PCT No.: PCT/CN2020/119354

§ 371 Date: Mar. 28, 2023

(51) Int. Cl. H04W 68/00; H04W 76/19

(52) U.S. Cl. CPC H04W 68/00; H04W 76/19; H04W 88/04

(57) ABSTRACT

Embodiments of the present application relate to methods and apparatuses for a relay reselection and data transmission handling procedure in a user equipment (UE)-to-network relay scenario under 3rd Generation Partnership Project (3GPP) 5G New Radio (NR). According to an embodiment of the present application, a method can include: establishing a Uu RRC connection of a link between the relay UE and a base station (BS); establishing a PC5 radio resource control (RRC) connection of a link between a UE and the relay UE; and transmitting a notification to the UE, wherein the notification is associated with at least one of: a radio link failure (RLF) of the link between the relay UE and the B S; a RLF recovery failure of the link between the relay UE and the B S; and a successful RLF recovery of the link between the relay UE and the BS. In response to receiving the notification, the UE may preform relay reselection and suspend the data transmission towards the BS.

### TECHNICAL FIELD

Embodiments of the present application generally relate to wireless communication technology, especially to methods and apparatuses for a relay reselection and data transmission handling procedure in a user equipment (UE)-to-network relay scenario.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a UE that is located in the coverage or far from the BS, which can result in relatively low signal quality. A RN may also be named as a relay UE in some cases. A 3GPP 5G sidelink system including a relay UE may be named as a sidelink relay system.

Currently, in a 3GPP 5G New Radio (NR) system or the like, details regarding how to design a relay reselection and data transmission handling procedure in a UE-to-network relay scenario have not been specifically discussed yet. A UE-to-network relay scenario may also be named as “a U2N relay scenario,” “a U2N relay,” or the like.

### SUMMARY

Some embodiments of the present application provide a method for wireless communications. The method may be performed by a relay UE. The method includes: establishing a Uu RRC connection of a link between the relay UE and a base station (BS); establishing a PC5 radio resource control (RRC) connection of a link between a UE and the relay UE; and transmitting a notification to the UE, wherein the notification is associated with at least one of: a radio link failure (RLF) of the link between the relay UE and the BS; a RLF recovery failure of the link between the relay UE and the BS; and a successful RLF recovery of the link between the relay UE and the BS.

Some embodiments of the present application provide a method for wireless communications. The method may be performed by a relay UE. The method includes: establishing a PC5 RRC connection of a link between a UE and the relay UE; establishing a Uu RRC connection of a link between the relay UE and a BS; and in response to detecting a PC5-signaling (PC5-S) link failure in the link between the UE and the relay UE, transmitting failure information to the BS.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a relay UE.

Some embodiments of the present application provide a further method for wireless communications. The method may be performed by a UE. The method includes: establishing a PC5 RC connection of a link between the UE and a relay UE, wherein a Uu RRC connection of a link between the relay UE and a BS has been established; and receiving a notification from one of the relay UE and the BS, wherein the notification received from the BS is a request to perform a relay reselection procedure, and wherein the notification received from the relay UE is associated with at least one of: a RLF of the link between the relay UE and the BS; a RLF recovery failure of the link between the relay UE and the BS; and a successful RLF recovery of the link between the relay UE and the BS.

Some embodiments of the present application provide a method for wireless communications. The method may be performed by a UE. The method includes: establishing a PC5 RRC connection of a link between the UE and a relay UE, wherein a Uu RRC connection of a link between the relay UE and a BS has been established; establishing a RRC relayed connection of the link between the UE and the BS; and performing a relay reselection procedure in response to an expiry of a timer for a RRC relayed connection reconfiguration of a link between the UE and the BS and in response to receiving a relay reselection indication from the BS.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary V2X communication system in accordance with some embodiments of the present application;

FIG. 3 illustrates an exemplary flowchart of a sidelink RRC reconfiguration procedure in accordance with some embodiments of the present application;

FIG. 4 illustrates an exemplary flowchart of a sidelink UE information procedure in accordance with some embodiments of the present application;

FIG. 5 illustrates an exemplary flowchart of a Layer-2 link maintenance procedure in accordance with some embodiments of the present application;

FIG. 6 illustrates a flow chart of a method for transmitting a notification to a UE in accordance with some embodiments of the present application;

FIG. 7 illustrates a flow chart of a method for receiving a notification from one of a BS and a relay UE in accordance with some embodiments of the present application;

FIG. 8 illustrates a flow chart of a method for performing a relay reselection procedure in accordance with some embodiments of the present application;

FIG. 9 illustrates a flow chart of a method for transmitting failure information to a BS in accordance with some embodiments of the present application; and

FIG. 10 illustrates a simplified block diagram of an apparatus for a failure handling procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

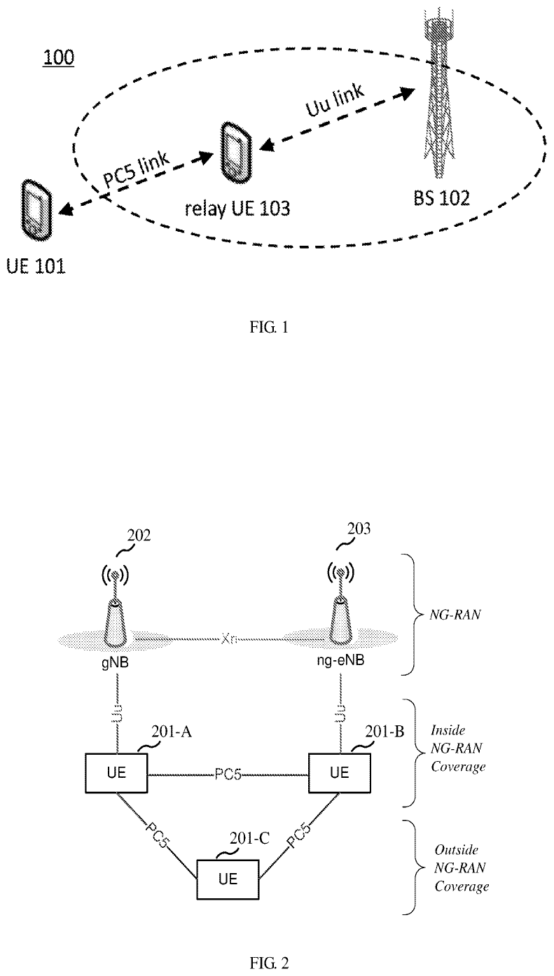

FIG. 1 illustrates a schematic diagram of a wireless communication system in accordance with some embodiments of the present application.

As shown in FIG. 1, the wireless communication system 100 includes UE 101, BS 102, and relay UE 103 for illustrative purpose. UE 101 may also be named as “a remote UE” or the like. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link.

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

Generally, sidelink communication supports UE-to-UE direct communication using two transmission modes. Two sidelink resource allocation modes are supported, namely, mode 1 and mode 2. In mode 1, the sidelink resource is scheduled by the BS. In mode 2, a UE decides the sidelink transmission resources and timing in the resource pool based on the measurement result and sensing result. Sidelink communication includes NR sidelink communication and V2X sidelink communication. FIG. 2 below demonstrates the NR sidelink communication. V2X sidelink communication is specified in 3GPP TS 36.300.

FIG. 2 illustrates an exemplary V2X communication system in accordance with some embodiments of the present application.

As shown in FIG. 2, the V2X communication system includes one gNB 202, one ng-eNB 203, and some V2X UEs, i.e., UE 201-A, UE 201-B, and UE 201-C. Each of these UEs may refer to UE 101a, UE 101b, or relay UE 103 as shown and illustrated in FIG. 1.

In particular, UE 201-A is within the coverage of gNB 202, UE 201-B is within the coverage of ng-eNB 203, and UE 201-C is out of coverage of gNB 202 and ng-eNB 203. Support of V2X services via the PC5 interface can be provided by NR sidelink communication and/or V2X sidelink communication. NR sidelink communication can support one of three types of transmission modes for a pair of a Source Layer-2 identity (ID) and a Destination Layer-2 ID: unicast transmission; groupcast transmission; and broadcast transmission. Sidelink transmission and reception over the PC5 interface are supported when the UE is either inside of the NG-RAN coverage or outside of the NG-RAN coverage.

UE 201-A, which is in the coverage of within the coverage of gNB 202, may perform sidelink unicast transmission, sidelink groupcast transmission, or sidelink broadcast transmission over the PC5 interface. UE 201-C, which is out of coverage, can also perform sidelink transmission and reception over the PC5 interface.

It is contemplated that, in accordance with some other embodiments of the present application, a V2X communication system may include more or fewer BSs, and more or fewer V2X UEs. Moreover, it is contemplated that names of V2X UEs (which represent a Tx UE, a Rx UE, and etc.) as illustrated and shown in FIG. 2 may be different, e.g., UE 201c, UE 204f, and UE 208g or the like.

In addition, although each V2X UE as shown in FIG. 2 is illustrated in the shape of a cell phone, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 2, UE 201-A functions as a Tx UE, and UE 201-B and UE 201-C function as a Rx UE. UE 201-A may exchange V2X messages with UE 201-B, or UE 201-C through a sidelink, for example, PC5 interface as defined in 3GPP TS 23.303. UE 201-A may transmit information or data to other UE(s) within the V2X communication system, through sidelink unicast, sidelink groupcast, or sidelink broadcast. The sidelink communication includes NR sidelink communication, and V2X sidelink communication. For instance, UE 201-A may transmit data to UE 201-C in a NR sidelink unicast session, and UE 201-B may transmit data to UE 201-C in a V2X sidelink unicast session. UE 201-A may transmit data to UE 201-B and UE 201-C in a groupcast group by a sidelink groupcast transmission session.

Sidelink communication includes NR Sidelink communication and V2X Sidelink communication. FIG. 2 demonstrates the NR Sidelink communication specified in 3GPP TS 38.311. V2X sidelink communication is specified in 3GPP TS 36.311.

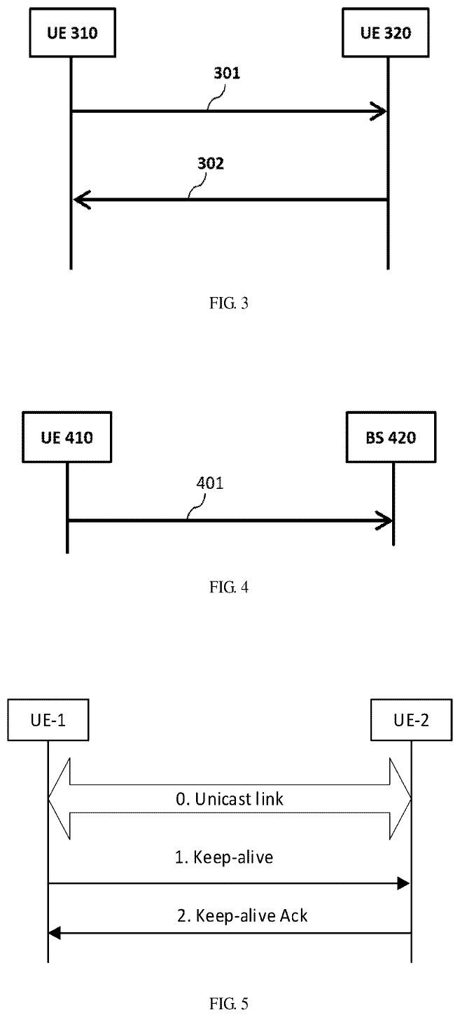

FIG. 3 illustrates an exemplary flowchart of a sidelink RRC reconfiguration procedure in accordance with some embodiments of the present application.

As shown in FIG. 3, in operation 301, UE 310 (e.g., UE 101a as illustrated and shown in FIG. 1) initiates a sidelink RRC reconfiguration procedure to UE 320 (e.g., relay UE 103 as illustrated and shown in FIG. 1) by transmitting RRCReconfigurationSidelink message to UE 320.

If the sidelink RRC reconfiguration procedure is successfully completed, in operation 302, UE 320 may transmit “a RRC reconfiguration complete sidelink message” to UE 310, e.g., RRCReconfigurationCompleteSidelink message as specified in 3GPP standard documents. Alternatively, if the sidelink RRC reconfiguration procedure is not successfully completed, in operation 302, UE 320 may transmit “a RRC reconfiguration failure sidelink message” to UE 310, e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE 310 as illustrated and shown in FIG. 3) may initiate the sidelink RRC reconfiguration procedure and perform operations on the corresponding PC5 RRC connection in following cases:
a release of sidelink DRBs associated with a peer UE (e.g., UE 320 as illustrated and shown in FIG. 3);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., an expiry of timer T400) or a sidelink RRC reconfiguration failure has been declared.

The following table shows introductions of some timers as specified in 3GPP standard documents, including a starting condition, a stop condition, an operation at expiry, and a possible general name for each of these timers.

| Timer | Start | Stop | At expiry | Name |
|---|---|---|---|---|
| T301 | Upon transmission of | Upon reception of | Go to a RRC_IDLE | A timer for RRC |
| | RRCReestabilshmentRequest | RRCReestablishment | state | Re-establishment |
| | | or RRCSetup message | | Request |
| | | as well as when the | | |
| | | selected cell becomes | | |
| | | unsuitable | | |
| T304 | Upon reception of | Upon successful | For T304 of MCG, | A Handover timer |
| | RRCReconfiguration | completion of | in case of the | |
| | message including | random access | handover from NR | |
| | reconfigurationWith | on the | or intra-NR | |
| | Sync or upon | corresponding | handover, initiate | |
| | conditional | SpCell For T304 | the RRC | |
| | reconfiguration | of SCG, upon | re-establishment | |
| | execution i.e., when | SCG release | procedure; In case | |
| | applying a stored | | of handover to NR, | |
| | RRCReconfiguration | | perform the actions | |
| | message including | | defined in the | |
| | reconfigurationWith | | specifications | |
| | Sync. | | applicable for the | |
| | | | source RAT. | |
| | | | For T304 of SCG, | |
| | | | inform network | |
| | | | about the | |
| | | | reconfiguration with | |
| | | | sync failure by | |
| | | | initiating the SCG | |
| | | | failure information | |
| | | | procedure as specified | |
| | | | in sub-clause 5.7.3 of | |
| | | | TS38.331. | |
| T316 | Upon transmission of the | Upon resumption of | Perform the actions as | A timer for fast |
| | MCGFailureInformation | MCG transmission, | specified in sub-clause | MCG link recovery |
| | message | upon reception of | 5.7.3b.5 of TS38.331. | |
| | | RRCRelease, or upon | | |
| | | initiating the | | |
| | | re-establishment | | |
| | | procedure | | |

FIG. 4 illustrates an exemplary flowchart of a sidelink UE information procedure in accordance with some embodiments of the present application.

As shown in FIG. 4, in operation 401, UE 410 (e.g., UE 101a as illustrated and shown in FIG. 1 or UE 310 as illustrated and shown in FIG. 3) transmits “a sidelink UE information message” to BS 420 (e.g., BS 102 as illustrated and shown in FIG. 1), e.g., SidelinkUEinformationNR message as specified in 3GPP standard documents. Specifically, the SidelinkUEinformationNR message may include sidelink failure information. The sidelink failure information may include a sidelink destination ID and a sidelink failure cause.

According to 3GPP standard documents, in a keep-alive procedure in a PC5-S layer, the PC5-S protocol shall support keep-alive functionality that is used to detect if a particular PC5 unicast link is still valid. UE(s) shall minimize the keep-alive signaling, e.g., cancel the procedure if data are successfully received over the PC5 unicast link.

FIG. 5 illustrates an exemplary flowchart of a Layer-2 link maintenance procedure in accordance with some embodiments of the present application.

As shown in FIG. 5, in step 0, UE-1 (e.g., UE 101a, UE 201-C, UE 310, or UE 410 as illustrated and shown in FIGS. 1-4) and UE-2 (e.g., relay UE 103, UE 201-A, or UE 320 as illustrated and shown in FIGS. 1-3) have a unicast link established. In step 1, UE-1 (e.g., UE 101a as illustrated and shown in FIG. 1) sends a Keep-alive message to UE-2 (e.g., relay UE 103 as illustrated and shown in FIG. 1) in order to determine the status of the PC5 unicast link based on the trigger condition. In step 2, upon receiving the Keep-alive message, UE-2 responds with a Keep-alive Ack message to UE-1. When UE-1 receives the response from UE-2, UE-1 stops “a timer for keep-alive procedure”. Otherwise, “the timer for keep-alive procedure” expires.

According to the 3GPP standard documents, an adaptation layer is supported over a PC5 link (i.e., a PC5 link between a relay UE and a remote UE) for Layer 2 (i.e., L2) UE-to-network relay scenario. For L2 UE-to-network relay scenario, the adaptation layer is put over a RLC sublayer for both control plane (CP) and user plane (UP) over the PC5 link. The sidelink service data adaptation protocol (SDAP) or the sidelink packet data convergence protocol (PDCP) and RRC are terminated between two Remote UEs, while RLC, MAC and PHY are terminated in each PC5 link.

Regarding Layer 3 (i.e., L3) UE-to-network relay scenario, a relay UE has full protocol stack. Namely, the user plane (UP) protocol stack of L3 relay UE includes the PHY, MAC, RLC, PDCP and SDAP layer. The control plane (CP) protocol stack of L3 relay UE includes the PHY, MAC, RLC, PDCP and RRC layer.

Currently, in a sidelink relay system under 3GPP 5G NR network, following issues need to be solved: what is the trigger condition for a remote UE to perform relay reselection in a UE-to-network relay scenario; what is the remote UE's behavior upon receiving a notification; and whether does a relay UE need to report to a BS when the relay UE fails to complete a keep-alive procedure in the UE-to-network relay scenario. Details regarding how to design a relay reselection procedure and a connection handling procedure in a UE-to-network relay scenario have not been specifically discussed yet. Embodiments of the present application provide a relay reselection and connection handling procedure in a UE-to-network relay scenario in a 3GPP 5G NR system or the like to solve the above issues. More details will be illustrated in the following text in combination with the appended drawings.

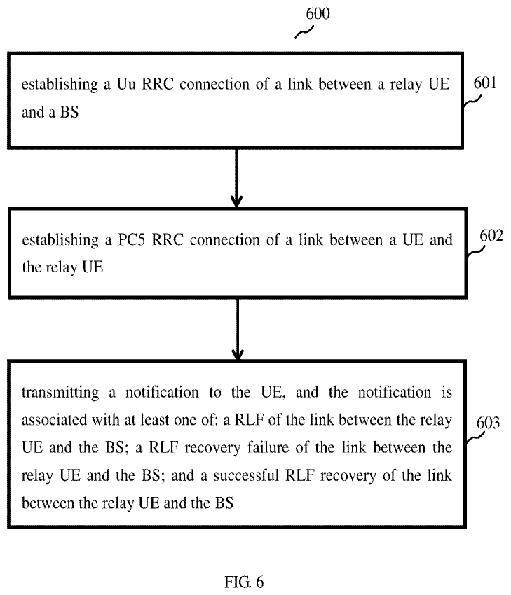

FIG. 6 illustrates a flow chart of a method for transmitting a notification to a UE in accordance with some embodiments of the present application.

The method may be performed by a relay UE (e.g., relay UE 103 illustrated and shown in FIG. 1, UE 201-A or UE 201-B as illustrated and shown in FIG. 2, or UE 320 as illustrated and shown in FIG. 3). Although described with respect to a relay UE, it should be understood that other devices may be configured to perform a method similar to that of FIG. 6.

In the exemplary method 600 as shown in FIG. 6, in operation 601, a Uu RRC connection of a link between a relay UE (e.g., relay UE 103 illustrated and shown in FIG. 1) and a BS (e.g., BS 102 illustrated and shown in FIG. 1) is established. In operation 602, a PC5 RRC connection of a link between a UE (e.g., UE 101a illustrated and shown in FIG. 1) and the relay UE is established.

In operation 603, the relay UE transmits a notification to the UE. For instance, the failure notification transmitted from the relay UE may be associated with at least one of: a RLF of the link between the relay UE and the BS; a RLF recovery failure of the link between the relay UE and the BS; and a successful RLF recovery of the link between the relay UE and the BS.

In some embodiments, the notification transmitted by the relay UE is a RLF notification. The RLF notification may be transmitted from the relay UE in response to one of:
(1) the relay UE detects a RLF in the link between the relay UE and the BS;
(2) the relay UE performs a fast master cell group (MCG) link recovery procedure on the link between the relay UE and the BS; and
(3) the relay UE performs a RRC re-establishment procedure on the link between the relay UE and the BS. To some extent, the RRC re-establishment procedure is a way to recover.

In some other embodiments, the notification is a successful recovery notification. In one example, in response to successfully completing a fast MCG link recovery procedure on the link between the relay UE and the BS, the relay UE transmits the successful recovery notification. In another example, in response to successfully completing a RRC re-establishment procedure on the link between the relay UE and the BS, the relay UE transmits the successful recovery notification.

In some further embodiments, the notification is a recovery failure notification. For instance, in response to failing to complete a RRC re-establishment procedure on the link between the relay UE and the BS, the relay UE transmits the recovery failure notification. Alternatively, in response to an expiry of a timer for a transmission of a RRC re-establishment request message, the relay UE transmits the recovery failure notification. For instance, if timer T301 expires, the relay UE transmits the recovery failure notification.

In some embodiments, the notification is transmitted by at least one of:
(1) a medium access control (MAC) control element (CE) of the relay UE;
(2) RRC signaling of the relay UE; and
(3) a control packet data unit (PDU) in an adaptation layer of the relay UE.

Details described in all other embodiments of the present application (for example, details regarding a notification transmitted from a relay UE) are applicable for the embodiments of FIG. 6. Moreover, details described in the embodiments of FIG. 6 are applicable for all the embodiments of FIGS. 1-5 and 7-10.

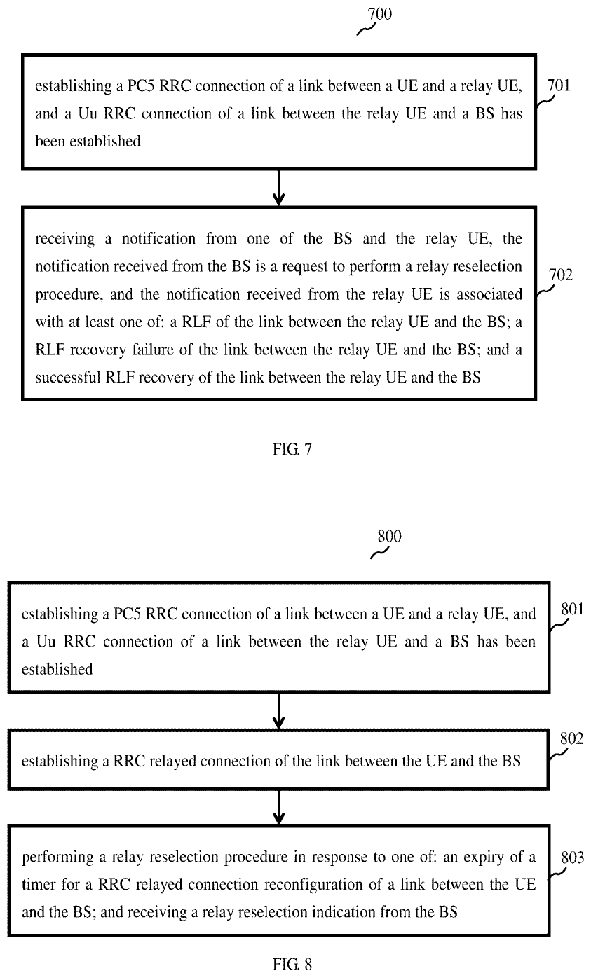

FIG. 7 illustrates a flow chart of a method for receiving a notification from one of a BS and a relay UE in accordance with some embodiments of the present application.

The method may be performed by a UE (e.g., UE 101a as illustrated and shown in FIG. 1, UE 201-C as illustrated and shown in FIG. 2, UE 310 as illustrated and shown in FIG. 3, or UE 410 as illustrated and shown in FIG. 4). Although described with respect to a UE, it should be understood that other devices may be configured to perform a method similar to that of FIG. 7.

In the exemplary method 700 as shown in FIG. 7, in operation 701, a PC5 RRC connection of a link between a UE (e.g., UE 101a illustrated and shown in FIG. 1) and a relay UE (e.g., relay UE 103 as illustrated and shown in FIG. 1) is established. The embodiments of FIG. 7 assume that a Uu RRC connection of a link between the relay UE and a BS (e.g., BS 102 illustrated and shown in FIG. 1) has been established.

In operation 702, the UE receives a notification from one of the BS and the relay UE. The notification received from the BS is a request to perform a relay reselection procedure. The notification received from the relay UE is associated with at least one of:
(1) a radio link failure (RLF) of the link between the relay UE and the BS;
(2) a RLF recovery failure of the link between the relay UE and the BS; and
(3) a successful RLF recovery of the link between the relay UE and the BS.

In some embodiments, the notification is a RLF notification transmitted from the relay UE. The relay UE may transmit the RLF notification after the relay UE detects a RLF in the link between the relay UE and the BS. The relay UE may transmit the RLF notification after the relay UE performs a fast MCG link recovery procedure on the link between the relay UE and the BS. Alternatively, the relay UE may transmit the RLF notification after the relay UE performs a RRC re-establishment procedure on the link between the relay UE and the BS.

In some other embodiments, the notification is a successful recovery notification. In one example, if the relay UE successfully completes a fast MCG link recovery procedure on the link between the relay UE and the BS, the relay UE transmits the successful recovery notification. In another example, if the relay UE successfully completes a RRC re-establishment procedure on the link between the relay UE and the BS, the relay UE transmits the successful recovery notification.

In some further embodiments, the notification is a recovery failure notification. For instance, if the relay UE fails to complete a RRC re-establishment procedure on the link between the relay UE and the BS, the relay UE transmits the recovery failure notification. Alternatively, upon an expiry of a timer for a transmission of a RRC re-establishment request message, the relay UE transmits the recovery failure notification. For instance, if timer T301 expires, the relay UE transmits the recovery failure notification.

In some embodiments, the notification is transmitted by at least one of: a MAC CE of the relay UE; RRC signaling of the relay UE; and a control PDU in an adaptation layer of the relay UE.

In some embodiments, in the exemplary method 700, the UE further performs a relay reselection procedure after receiving a notification associated with at least one of “a RLF of the link between the relay UE and the BS” and “a RLF recovery failure of the link between the relay UE and the BS”.

In an embodiment, if the UE receives a notification associated with the RLF of the link between the relay UE and the BS, the UE may suspend at least one of:
a data radio bearer (DRB) terminated in the BS;
a transmission of data terminated in the BS; and
a transmission of signaling terminated in the BS.

In some other embodiments, if the UE receives a notification associated with the RLF of the link between the relay UE and the BS, the UE may continue to transmit, to the relay UE, data terminated in the relay UE and continue to receive data from the relay UE.

In some embodiments, if the UE receives an end-mark indication from the relay UE, the UE stops receiving data from the relay UE. In some further embodiments, if the UE receives a RRC message and the RRC message includes an indication of completing a transmission of data which is terminated in the UE, the UE stops receiving data from the relay UE.

In an embodiment, an AS layer of the UE may transmit an indication to a PC5-S layer of the UE, to indicate that the UE has stopped receiving the data from the relay UE.

In a further embodiment, an AS layer of the UE may transmit an indication to a PC5-S layer of the UE, to indicate an occurrence of a failure in the link between the relay UE and the BS. Then, the PC5-S layer of the UE transmits a discovery message to the AS layer of the UE.

In some embodiments, if the UE receives the notification associated with the RLF of the link between the relay UE and the BS, the UE initiates a relay discovery procedure or initiates a relay reselection procedure. In some other embodiments, if the UE receives the notification associated with the RLF recovery failure of the link between the relay UE and the BS, the UE initiates a relay discovery procedure or initiates a relay reselection procedure.

In some embodiments, the UE may receive a successful recovery notification from the relay UE, and the UE resuming at least one of: a DRB terminated in the BS; a transmission of data terminated in the BS; and a transmission of signaling terminated in the BS.

Details described in all other embodiments of the present application (for example, details regarding a notification received from a BS or a relay UE) are applicable for the embodiments of FIG. 7. Moreover, details described in the embodiments of FIG. 7 are applicable for all the embodiments of FIGS. 1-6 and 8-10.

FIG. 8 illustrates a flow chart of a method for performing a relay reselection procedure in accordance with some embodiments of the present application.

The method may be performed by a UE (e.g., UE 101a as illustrated and shown in FIG. 1, UE 201-C as illustrated and shown in FIG. 2, UE 310 as illustrated and shown in FIG. 3, or UE 410 as illustrated and shown in FIG. 4). Although described with respect to a UE, it should be understood that other devices may be configured to perform a method similar to that of FIG. 8.

In the exemplary method 800 as shown in FIG. 8, in operation 801, a PC5 RRC connection of a link between a UE (e.g., UE 101a illustrated and shown in FIG. 1) and a relay UE (e.g., relay UE 103 as illustrated and shown in FIG. 1) is established. The embodiments of FIG. 8 assume that a Uu RRC connection of a link between the relay UE and a BS (e.g., BS 102 illustrated and shown in FIG. 1) has been established.

In operation 802, a RRC relayed connection of the link between the UE and the BS is established. In operation 803, the UE performs a relay reselection procedure in response to “an expiry of a timer for a RRC relayed connection reconfiguration of a link between the UE and the BS” or “receiving a relay reselection indication from the BS.”

A RRC relayed connection of a link between the UE and the BS may also be named as “an end-to-end RRC connection of a relayed link,” “an end-to-end RRC connection,” “an end-to-end relayed connection,” “a relayed RRC connection,” or the like.

In some embodiments, the UE may further transmit a RRC message to the BS. The RRC message may be relayed by the relay UE to the BS. Upon transmitting the RRC message, the UE may start the timer for the RRC relayed connection reconfiguration.

In some embodiments, the UE receives, from the BS, measurement configuration information including identity information of a candidate relay UE. Then, the UE performs measurement to the candidate relay UE, and transmits a measurement result of the measurement to the BS. For example, based on a condition that a channel quality of a link between the UE and the relay UE is equal to or less than a threshold value, the UE may perform measurement to the candidate relay UE and a serving cell of the UE (if any) as well as neighbour cell(s) of the UE. If the UE is in coverage of the BS, the UE has a serving cell and may perform the measurement to the serving cell. Otherwise, the UE cannot find a serving cell, but may only perform measurement to a candidate relay UE and neighbour cell(s) of the UE. Then, the UE transmits a measurement result of the performed measurement to the BS. Based on the received measurement result, the BS may transmit a relay reselection indication to the UE. Upon receiving the relay reselection indication, the UE may perform a relay reselection procedure.

In some embodiments, the UE receives a RRC message from the BS. The RRC message includes the relay reselection indication. In an embodiment, the relay reselection indication is associated with a measurement result of measurement performed by the UE. For example, the measurement is performed to a candidate relay UE, a serving cell of the UE (if any) and neighbour cell(s) of the UE.

Details described in all other embodiments of the present application (for example, details regarding a trigger condition to perform a relay reselection procedure) are applicable for the embodiments of FIG. 8. Moreover, details described in the embodiments of FIG. 8 are applicable for all the embodiments of FIGS. 1-7, 9, and 10.

The following texts describe specific Embodiments 1-4 of the methods as shown and illustrated in any of FIGS. 6-8.

### Embodiment 1

Embodiment 1 is for a L3 UE-to-network relay scenario. There is no end-to-end RRC connection between a remote UE and a BS) in Embodiment 1. According to Embodiment 1, UE1 (e.g., UE 101 as shown and illustrated in FIG. 1, which functions as a remote UE), a relay UE (e.g., relay UE 103 illustrated and shown in FIG. 1), and a BS (e.g., BS 102 as illustrated and shown in FIG. 1) perform the following steps:
(1) Step 1: A PC5 RRC connection between UE1 and a relay UE has been established. A Uu RRC connection between the relay UE and a BS has been established.
(2) Step 2: The relay UE transmits a notification to UE1 based on at least one of the following conditions.
   When a RLF on Uu interface between the relay UE and the BS happens, the relay UE transmits a notification associated with the RLF to UE1.
      For instance, the notification associated with the RLF is a RLF notification. The relay UE may transmit the RLF notification upon detecting the RLF. The RLF notification may be carried on a MCG link via a MAC CE of the relay UE. The RLF notification may be carried on a RRC message of the relay UE. Alternatively, the RLF notification may be carried on an adaptation layer control PDU of the relay UE.
   When a RLF recovery procedure fails on Uu interface between the relay UE and the BS, the relay UE transmits, to UE1, a notification associated with a RLF recovery failure.
(3) Step 3: After receiving the notification from the relay UE, UE1 performs a relay reselection procedure.

### Embodiment 2

Embodiment 2 is for a L2 UE-to-network relay scenario. There is an end-to-end RRC connection between a remote UE and a BS) in Embodiment 2. According to Embodiment 2, UE1 (e.g., UE 101 as shown and illustrated in FIG. 1, which functions as a remote UE), a relay UE (e.g., relay UE 103 illustrated and shown in FIG. 1), and a BS (e.g., BS 102 as illustrated and shown in FIG. 1) perform the following steps:
(1) Step 1: A PC5 RRC connection between UE1 and a relay UE has been established. A Uu RRC connection between the relay UE and a BS has been established.
(2) Step 2: The end-to-end RRC connection between UE1 and the BS is established.
   UE1 transmits a RRC setup request to the BS via the relay UE.
   The BS transmits a RRC setup message to UE1 via the relay UE. The RRC setup message includes the response for UE1.
(3) Step 3: The relay UE transmits a notification to UE1 based on at least one of the following conditions.
   A Timer for end-to-end RRC message expires
      UE1 transmits a RRC message to the BS, which is relayed by the relay UE to the BS. One timer is used to control the RRC procedure. This timer may also be named as “a timer for end-to-end RRC message” or like. UE1 starts this timer when UE1 transmits the RRC message. If the UE receives a response or a feedback from the BS, the UE stops this timer. Otherwise, once this timer expires, UE1 is triggered to perform a relay reselection procedure.
   UE1 receives a RRC message from the BS, and the RRC message includes a relay reselection indication.
      The RRC message received from the BS may further include identity information of a candidate relay UE. The BS may configure the UE to perform measurement toward the candidate relay UE, a serving cell of UE1 and neighbour cell(s) of UE1. UE1 may report, to the BS, a measurement result of its measurement, e.g., in a measurement report.
   Based on a measurement report from UE1, the BS may configure UE1 to perform a relay reselection procedure.
(4) Step 4: UE1 performs the relay reselection procedure.

### Embodiment 3

According to Embodiment 3, UE1 (e.g., UE 101 as shown and illustrated in FIG. 1, which functions as a remote UE), a relay UE (e.g., relay UE 103 illustrated and shown in FIG. 1), and a BS (e.g., BS 102 as illustrated and shown in FIG. 1) perform the following steps:
(1) Step 1: A PC5 RRC connection between UE1 and a relay UE has been established. A Uu RRC connection between the relay UE and a BS has been established.
(2) Step 2 (optional): The end-to-end RRC connection between UE1 and the BS is established, if the UE-to-network relay is a L2 relay scenario.
   UE1 transmits a RRC setup request to the BS via the relay UE.
   The BS transmits a RRC setup message to UE1 via the relay UE. The RRC setup message includes the response for UE1.
(3) Step 3: The relay UE transmits a notification to UE1 based on at least one of the following conditions.
   The relay UE transmits a RLF notification to UE1 when:
      a RLF between relay UE and BS happens; or
      the relay UE is triggered to perform a fast MCG link recovery procedure; or
      the relay UE is triggered to perform a RRC re-establishment procedure.
   The RLF notification can be transmitted by a MAC CE of the relay UE, RRC signaling of the relay UE, or a control PDU in an adaptation layer of the relay UE.
Step 4: UE1 receives the RLF notification from the relay UE.
   After UE1 receives the RLF notification from the relay UE, UE1 suspends the DRB or data and signaling transmission terminated in the BS.
      UE1 may continue to transmit data transmission, which is terminated in the relay UE, to the relay UE.
      UE1 may continue to receive data from the relay UE. The data in the relay UE's buffer could be transmitted from the BS.
         The relay UE may transmit end-mark information to UE1, after the relay UE completes the data transmission. Optionally, the relay UE may transmit a RRC message to UE1, to indicate a completion of the data transmission. Then, UE1 will perform a relay reselection procedure.
      UE1 is triggered to initiate a discovery procedure or a relay reselection procedure.
      An AS layer of UE1 informs an upper layer of UE1 (, e.g., a V2X layer or a PC5-S layer) that a failure happens in Uu interface. Then, the upper layer of UE1 delivers a discovery message to the AS layer of UE1 for a transmission purpose.
Step 5: The relay UE transmits a successful recovery notification, upon “a successful fast MCG link recovery procedure” or “a successful re-establishment recovery procedure.”
   After receiving the successful recovery notification from the relay UE, UE1 may resume a data transmission with the BS.
   The successful recovery notification can be transmitted by a MAC CE of the relay UE, RRC signaling of the relay UE, or a control PDU in an adaptation layer of the relay UE.

### Embodiment 4

According to Embodiment 4, UE1 (e.g., UE 101 as shown and illustrated in FIG. 1, which functions as a remote UE), a relay UE (e.g., relay UE 103 illustrated and shown in FIG. 1), and a BS (e.g., BS 102 as illustrated and shown in FIG. 1) perform the following steps:
(1) A PC5 RRC connection between UE1 and a relay UE has been established. A Uu RRC connection between the relay UE and a BS has been established.
(2) Step 2 (optional): The end-to-end RRC connection between UE1 and the BS is established, if the UE-to-network relay is a L2 relay scenario.
   UE1 transmits a RRC setup request to the BS via the relay UE.
   The BS transmits a RRC setup message to UE1 via the relay UE. The RRC setup message includes the response for UE1.
(3) Step 3: The relay UE transmits a recovery failure notification to UE1 based on at least one of the following conditions.
   The relay UE transmits a recovery failure notification to UE1 upon a recovery failure, such as, an expiry of timer T304 or an expiry of timer T301.
      When UE1 receives the recovery failure notification, UE1 is triggered to perform a relay reselection procedure.
   The recovery failure notification can be transmitted by a MAC CE of the relay UE, RRC signaling of the relay UE, or a control PDU in an adaptation layer of the relay UE.

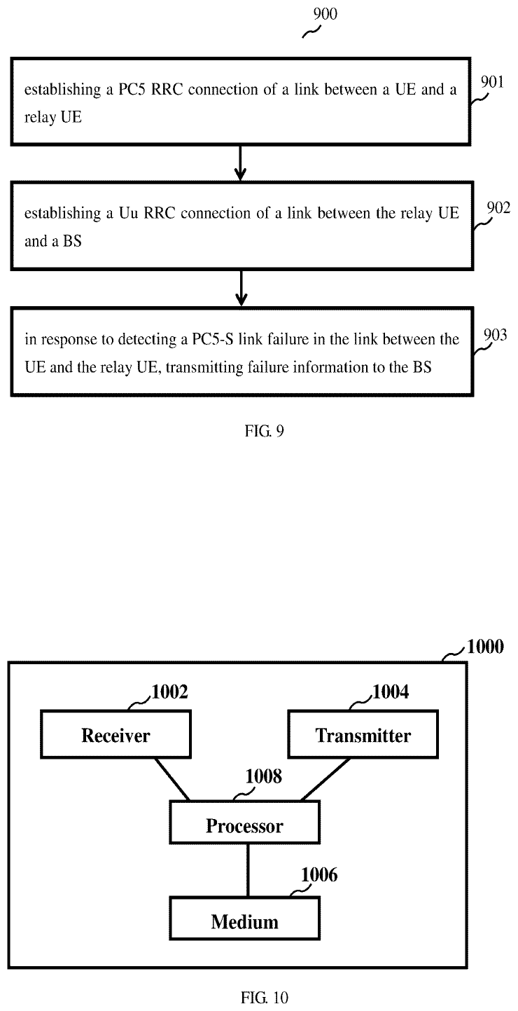

FIG. 9 illustrates a flow chart of a method for transmitting failure information to a BS in accordance with some embodiments of the present application.

The method may be performed by a relay UE (e.g., relay UE 103 illustrated and shown in FIG. 1, UE 201-A or UE 201-B as illustrated and shown in FIG. 2, or UE 320 as illustrated and shown in FIG. 3). Although described with respect to a relay UE, it should be understood that other devices may be configured to perform a method similar to that of FIG. 9.

In the exemplary method 900 as shown in FIG. 9, in operation 901, a PC5 RRC connection of a link between a UE (e.g., UE 101a illustrated and shown in FIG. 1) and a relay UE (e.g., relay UE 103 illustrated and shown in FIG. 1) is established. In operation 902, a Uu RRC connection of a link between the relay UE and a BS (e.g., BS 102 as illustrated and shown in FIG. 1) is established.

In operation 903, in response to detecting a PC5-S link failure in the link between the UE and the relay UE, the relay UE transmits failure information to the UE.

In some embodiments, the relay UE transmits the failure information in response to at least one of:
an expiry of a timer for keep-alive procedure, wherein the timer for keep-alive procedure is associated with the link between the UE and the relay UE;
an AS layer of the relay UE receives, from a PC5-S layer of the relay UE, an indication of the PC5-S link failure; and
the relay UE declares a sidelink RLF upon detecting the PC5-S link failure.

In some embodiments, the failure information is a sidelink failure notification, and the sidelink failure notification includes a cause. The cause may be at least one of:
1) an expiry of a timer for keep-alive procedure, wherein the timer for keep-alive procedure is associated with the link between the UE and the relay UE; and
2) an occurrence of the PC5-S link failure.

Details described in all other embodiments of the present application (for example, details regarding failure information transmitted to a BS) are applicable for the embodiments of FIG. 9. Moreover, details described in the embodiments of FIG. 9 are applicable for all the embodiments of FIGS. 1-8 and 10.

The following texts describe specific Embodiment 5 of the method as shown and illustrated in FIG. 9.

### Embodiment 5

According to Embodiment 5, UE1 (e.g., UE 101 as shown and illustrated in FIG. 1, which functions as a remote UE), a relay UE (e.g., relay UE 103 illustrated and shown in FIG. 1), and a BS (e.g., BS 102 as illustrated and shown in FIG. 1) perform the following steps:
(1) A PC5 RRC connection between UE1 and a relay UE has been established. A Uu RRC connection between the relay UE and a BS has been established.
(2) Step 2 (optional): The end-to-end RRC connection between UE1 and the BS is established, if the UE-to-network relay is a L2 relay scenario.
   UE1 transmits a RRC setup request to the BS via the relay UE.
   The BS transmits a RRC setup message to UE1 via the relay UE. The RRC setup message includes the response for UE1.
(3) Step 3: The relay UE transmits a Keep-alive message to UE1, in order to determine a status of the PC5 unicast link, based on a trigger condition.
   The relay UE starts one timer for keep-alive procedure.
(4) Step 4: The timer for keep-alive procedure expires. The relay UE is triggered to report an indication to the BS, e.g., via SidelinkUElnformation message.
   The timer for keep-alive procedure expires. The relay UE may be triggered to report failure information to the BS after the timer for keep-alive procedure expires. Then, the BS may stop a data transmission for UE1.
      The relay UE may be triggered to report failure information to the BS based on one of the following conditions:
         1. an expiry of the timer for keep-alive procedure;
         2. an AS layer of the relay UE receives a PC5-S link failure from a PC5-S layer of the relay UE; and
         3. the relay UE declares a sidelink RLF because of detecting the PC5-S link failure.
      The reported failure information could be a sidelink failure notification.

The sidelink failure notification may include a cause, e.g., “a PC5 link failure” or “an expiry of the timer for keep-alive procedure.”

FIG. 10 illustrates a simplified block diagram of an apparatus for a failure handling procedure in accordance with some embodiments of the present application.

In some embodiments of the present application, the apparatus 1000 may be a UE (e.g., UE 101 as illustrated and shown in FIG. 1, UE 201-C as illustrated and shown in FIG. 2, UE 310 as illustrated and shown in FIG. 3, or UE 410 as illustrated and shown in FIG. 4), which can at least perform the method illustrated in FIG. 7 or FIG. 8.

In some other embodiments of the present application, the apparatus 1000 may be a relay UE (e.g., relay UE 103 as illustrated and shown in FIG. 1, UE 201-A or UE 201-B as illustrated and shown in FIG. 2, or UE 320 as illustrated and shown in FIG. 3), which can at least perform the method illustrated in FIG. 6 or FIG. 9. In some additional embodiments of the present application, the apparatus 1000 may be a BS (e.g., BS 102 as illustrated and shown in FIG. 1 or BS 420 as illustrated and shown in FIG. 4).

As shown in FIG. 10, the apparatus 1000 may include at least one receiver 1002, at least one transmitter 1004, at least one non-transitory computer-readable medium 1006, and at least one processor 1008 coupled to the at least one receiver 1002, the at least one transmitter 1004, and the at least one non-transitory computer-readable medium 1006.

Although in FIG. 10, elements such as the at least one receiver 1002, the at least one transmitter 1004, the at least one non-transitory computer-readable medium 1006, and the at least one processor 1008 are described in the singular, the plural is contemplated unless limitation to the singular is explicitly stated. In some embodiments of the present application, the at least one receiver 1002 and the at least one transmitter 1004 are combined into a single device, such as a transceiver. In certain embodiments of the present application, the apparatus 1000 may further include an input device, a memory, and/or other components.

In some embodiments of the present application, the at least one non-transitory computer-readable medium 1006 may have stored thereon computer-executable instructions which are programmed to implement the operations of the methods, for example as described in view of any one of FIGS. 6-9, with the at least one receiver 1002, the at least one transmitter 1004, and the at least one processor 1008.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

What is claimed is:

1. An apparatus, comprising:
a memory; and
a processor coupled to the memory, the processor configured to cause the apparatus to:
establish a Uu radio resource control (RRC) connection of a link between a relay user equipment (UE) and a base station (BS);
establish a PC5 RRC connection of a link between a first UE and the relay UE; and
transmit a notification to the first UE, wherein the notification is associated with at least one of:
a radio link failure (RLF) of the link between the relay UE and the BS;
a RLF recovery failure of the link between the relay UE and the BS; or
a successful RLF recovery of the link between the relay UE and the BS.

2. The apparatus of claim 1, wherein the notification is-comprises a RLF notification, and the RLF notification is transmitted from the relay UE in response to at least one of:
detecting a RLF in the link between the relay UE and the BS;
the relay UE performing a fast master cell group (MCG) link recovery procedure on the link between the relay UE and the BS; or
the relay UE performing a RRC re-establishment procedure on the link between the relay UE and the BS.

3. The apparatus of claim 1, wherein the notification comprises a successful recovery notification, and the successful recovery notification is transmitted from the relay UE in response to at least one of:
successfully completing a fast master cell group (MCG) recovery procedure on the link between the relay UE and the BS; or
successfully completing a RRC re-establishment procedure on the link between the relay UE and the BS.

4. The apparatus of claim 1, wherein the notification comprises a recovery failure notification, and the recovery failure notification is transmitted from the relay UE in response to at least one of:
a failure to complete a RRC re-establishment procedure on the link between the relay UE and the BS; or
an expiry of a timer for a transmission of a RRC re-establishment request message.

5. The apparatus of claim 1, wherein the notification is transmitted by at least one of:
a medium access control control element (MAC CE);
RRC signaling; or
a control packet data unit (PDU) in an adaptation layer of the relay UE.

6. An apparatus, comprising:
a memory; and
a processor coupled to the memory, the processor configured to cause the apparatus to:
establish a PC5 radio resource control (RRC) connection of a link between a first user equipment (UE) and a relay UE, wherein a Uu RRC connection of a link between the relay UE and a base station (BS) has been established; and
receive a notification from one of the BS or the relay UE,
wherein the notification received from the BS comprises a request to perform a relay reselection procedure,
wherein the notification received from the relay UE is associated with at least one of:
a radio link failure (RLF) of the link between the relay UE and the BS;
a RLF recovery failure of the link between the relay UE and the BS; or
a successful RLF recovery of the link between the relay UE and the BS.

7. The apparatus of claim 6, wherein the notification comprises a RLF notification transmitted from the relay UE, and the RLF notification is transmitted from the relay UE in response to at least one of:
the relay UE detecting a RLF in the link between the relay UE and the BS;
the relay UE performing a fast master cell group (MCG) link recovery procedure on the link between the relay UE and the BS; or
the relay UE performing a RRC re-establishment procedure on the link between the relay UE and the BS.

8. The apparatus of claim 6, wherein the notification comprises a successful recovery notification, and the successful recovery notification is transmitted from the relay UE in response to at least one of:
the relay UE successfully completing a fast MCG link recovery procedure on the link between the relay UE and the BS; or
the relay UE successfully completing a RRC re-establishment procedure on the link between the relay UE and the BS.

9. The apparatus of claim 6, wherein the failure notification comprises a recovery failure notification, and the recovery failure notification is transmitted from the relay UE in response to at least one of:
the relay UE failing to complete a RRC re-establishment procedure on the link between the relay UE and the BS; or
an expiry of a timer for a transmission of a RRC re-establishment request message.

10. The apparatus of claim 6, wherein the notification is transmitted by at least one of:
a medium access control control element (MAC CE);
RRC signaling; or
a control packet data unit (PDU) in an adaptation layer of the relay UE.

11. The apparatus of claim 6, wherein the processor is configured to cause the apparatus to:
perform a relay reselection procedure after receiving a notification associated with at least one of:
a radio link failure (RLF) of the link between the relay UE and the BS; or
a RLF recovery failure of the link between the relay UE and the BS.

12. The apparatus of claim 6, wherein in response to receiving the notification associated with the RLF of the link between the relay UE and the BS, the processor is configured to cause the apparatus to:
suspend at least one of:
a data radio bearer (DRB) terminated in the BS;
a transmission of data terminated in the BS; or
a transmission of signaling terminated in the BS.

13. The apparatus of claim 6, wherein in response to receiving the notification associated with the RLF of the link between the relay UE and the BS or the RLF recovery failure of the link between the relay UE and the BS, the processor is configured to cause the apparatus to one or more of:
initiate a relay discovery procedure; or
initiate a relay reselection procedure.

14. The apparatus of claim 6, wherein the processor is configured to cause the apparatus to:
transmit, by an access stratum (AS) layer of the first UE, an indication to a PC5-S layer of the first UE, wherein the indication indicates an occurrence of a failure in the link between the relay UE and the BS; and
transmit, by the PC5-S layer of the first UE, a discovery message to the AS layer of the first UE.

15. (canceled)

16. The apparatus of claim 6, wherein in response to receiving the notification associated with the RLF of the link between the relay UE and the BS, the processor is configured to cause the apparatus to:
continue to transmit, to the relay UE, data terminated in the relay UE; and
continue to receive data from the relay UE.

17. A method, comprising:
establishing a Uu radio resource control (RRC) connection of a link between a relay user equipment (UE) and a base station (BS);
establishing a PC5 RRC connection of a link between a first UE and the relay UE; and
transmitting a notification to the first UE, wherein the notification is associated with at least one of:
a radio link failure (RLF) of the link between the relay UE and the BS;
a RLF recovery failure of the link between the relay UE and the BS; or
a successful RLF recovery of the link between the relay UE and the BS.

18. The method of claim 17, wherein the notification comprises a RLF notification, and the RLF notification is transmitted from the relay UE in response to at least one of:
detecting a RLF in the link between the relay UE and the BS;
the relay UE performing a fast master cell group (MCG) link recovery procedure on the link between the relay UE and the BS; or
the relay UE performing a RRC re-establishment procedure on the link between the relay UE and the BS.

19. The method of claim 17, wherein the notification comprises a successful recovery notification, and the successful recovery notification is transmitted from the relay UE in response to at least one of:
successfully completing a fast master cell group (MCG) link recovery procedure on the link between the relay UE and the BS; or
successfully completing a RRC re-establishment procedure on the link between the relay UE and the BS.

20. The method of claim 17, wherein the notification comprises a recovery failure notification, and the recovery failure notification is transmitted from the relay UE in response to at least one of:
a failure to complete a RRC re-establishment procedure on the link between the relay UE and the BS; or
an expiry of a timer for a transmission of a RRC re-establishment request message.

21. The method of claim 17, wherein the notification is transmitted by at least one of:
a medium access control control element (MAC CE);
RRC signaling; or
a control packet data unit (PDU) in an adaptation layer of the relay UE.
